(19) United States
(12) Patent Application Publication
(10) Pub. No.: US 2017/0321625 A1
(43) Pub. Date: Nov. 9, 2017

(54) PISTON ASSEMBLY FOR AN ENGINE

(71) Applicant: Ning Tao, Beijing (CN)

(72) Inventors: Ning Tao, Beijing (CN); Shaoping Wang, Madison, WI (US)

(21) Appl. No.: 15/534,494

(22) PCT Filed: Dec. 10, 2015
(86) PCT No.: PCT/CN2015/096880

§ 371 Date: Jun. 9, 2017

(30) Foreign Application Priority Data
Dec. 12, 2014 (CN) 201410759592.5

(51) Int. Cl. F02F 3/02; F16J 9/12; F02F 3/22

(52) U.S. Cl. CPC F02F 3/027; F02F 3/22; F16J 9/12

(57) ABSTRACT

In an engine piston assembly of the present invention, a piston structure, together with a piston ring set matched to the piston structure and an inner wall of a cylinder bore body, forms a crevice passage having at least two annular expansion chambers and also having a function of multistage throttling and expansion. The engine piston assembly of the present invention can not only greatly and effectively reduce the intra-cylinder carbon deposition and the hydrocarbon emissions in the exhaust gas emissions of the engine, but also significantly improve the engine efficiency and the overall performance of the engine, so that the present invention is suitable for wide applications.

### TECHNICAL FIELD OF THE INVENTION

The present invention relates to the field of engine parts and fittings and in particular to an engine piston assembly.

### BACKGROUND OF THE INVENTION

The regulations for the emission control of engines are getting more and more rigorous. For a piston assembly consisting of a piston body and a piston ring set, which is one of key sub-components for an engine, the matched design between the overall structure of the piston assembly and its constitution parts has decisive influence on the amount of hydrocarbons in the exhaust emissions. Firstly, during the exhaust process of an engine cycle, part of hydrocarbons in a crevice between the piston and the piston rings as well as a crevice between the piston and the cylinder bore wall (mainly a crevice above a first compression piston ring and a part of a crevice between the first compression piston ring and a second compression piston ring) will escape from an exhaust valve together with the burnt gas. Secondly, during the compression stroke, ignition and expansion stroke of an engine cycle, part of unburned high-pressure fuel-air mixture and the burned high-temperature and high-pressure gas enter the crankcase of the engine through the crevices between the piston and the piston rings as well as the crevices between the piston and the cylinder bore due to a large difference in pressure, so that the blow-by gas leakage of the unburned fuel-air mixture and the burned gas is caused. The blow-by gas leakage generally will result in the rise of temperature and pressure of the oil in the crankcase so as to form oil vapor. The oil vapor, together with the blow-by gas of the unburned fuel-air mixture and the burned gas, enters a breathing apparatus of the engine. Part of the oil vapor will enter the combustion chamber to participate in combustion to form unburned hydrocarbon emissions which are exhausted out from the exhaust valve along with the burnt gas. Thirdly, the sustained combustion of the engine oil will form carbon deposition on the top of the piston and on the surface of the combustion chamber. The formation of the carbon deposition will provide a hotbed for unburned hydrocarbons, and the hydrocarbons in the carbon deposition will escape from the exhaust valve together with the burnt gas during the exhaust process. Apparently, the amount of blow-by gas leakage of the unburned fuel-air mixture and the burned gas has a non-negligible and direct impact on the hydrocarbon emissions.

In an existing engine, since the piston assembly is of a piston structure having equal land diameters and equal groove depths, accordingly, the first compression piston ring and the second compression piston ring are usually of a structure having an equal radial thickness. A crevice passage formed by a piston, a corresponding piston ring set and a cylinder bore wall is unable to generate high enough flow resistance and great energy dissipation effect due to the lack of significant multi-stage suddenly-converged and suddenly-enlarged features, it is thus very difficult to avoid a large amount of blow-by gas leakage of the unburned high-pressure fuel-air mixture and the burned high-temperature and high-pressure gas, and the effect is limited even if various methods for reducing the crevices are tried.

### SUMMARY OF THE INVENTION

A technical problem mainly to be solved by the present invention is to provide a engine piston assembly. A piston structure, together with a piston ring set and an inner wall of a cylinder bore body both matched to the piston structure, forms a crevice passage having at least one annular expansion chamber and also having a function of multistage throttling and expansion. The crevice passage will generate high enough flow resistance and great energy dissipation effect in the compression, ignition and expansion processes of the fuel-air mixture of an engine cycle, and thus can effectively prevent the unburned high-pressure fuel-air mixture and the burned high-temperature and high-pressure gas from blow-by leaking out from the combustion chamber and the cylinder to the crankcase of the engine; and, in the exhaust process, the crevice passage can ensure that only few hydrocarbon emissions may escape from the crevices. The engine piston assembly of the present invention can not only greatly and effectively reduce the intra-cylinder carbon deposition and the hydrocarbon emissions in the exhaust gas emissions of the engine, but also significantly improve the engine efficiency and the overall performance of the engine, so that the present invention is suitable for wide applications.

To solve the technical problem, the piston assembly comprises a cylinder bore body with an inner wall, a piston body, a first compression piston ring, a second compression piston ring and an oil ring assembly; wherein, the first compression piston ring, the second compression piston ring and the oil ring assembly each contacts with the inner wall of the cylinder bore body; a top land, a first compression ring groove, a second land, a second compression ring groove, a third land, and an oil ring groove are disposed in turn on the periphery of the piston body from top to bottom; the first compression ring groove and the second compression ring groove have equal or unequal depths, and a ratio of the depth of the first compression ring groove to the depth of the second compression ring groove is less than or equal to 1.0; the first compression piston ring and the second compression piston ring have equal or unequal radial thicknesses, and a ratio of the radial thickness of the first compression piston ring to the radial thickness of the second compression piston ring is less than or equal to 1.0; and at least one annular expansion chamber is disposed between the second land and the inner wall of the cylinder bore body, and the at least one annular expansion chamber is defined by the region between at least one annular expansion groove disposed on the periphery of the second land and the inner wall of the cylinder bore body.

As a preferred embodiment of the present invention, at least one annular expansion chamber is also disposed between the third land and the inner wall of the cylinder bore body, and the at least one annular expansion chamber is defined by the region between at least one annular expansion groove disposed on the periphery of the third land and the inner wall of the cylinder bore body.

To solve the technical problem, another engine piston assembly is provided, the piston assembly comprises a cylinder bore body with an inner wall, a piston body, a first compression piston ring, a second compression piston ring and an oil ring assembly; wherein, the first compression piston ring, the second compression piston ring and the oil ring assembly each contacts with the inner wall of the cylinder bore body; a first land, a first compression ring groove, a second land, a second compression ring groove, a third land, and an oil ring groove are disposed in turn on the periphery of the piston body from top to bottom; the first compression ring groove and the second compression ring groove have equal or unequal depths, and a ratio of the depth of the first compression ring groove to the depth of the second compression ring groove is less than or equal to 1.0; the first compression piston ring and the second compression piston ring have equal or unequal radial thicknesses, and a ratio of the radial thickness of the first compression piston ring to the radial thickness of the second compression piston ring is less than or equal to 1.0; and at least one annular expansion chamber is disposed between the third land and the inner wall of the cylinder bore body, and the at least one annular expansion chamber is defined by region between at least one annular expansion groove disposed on the periphery of the third land and the inner wall of the cylinder bore body.

As a preferred embodiment of the present invention, one of the annular expansion chambers is also disposed in a crevice region between the second compression piston ring and the second compression ring groove.

As a preferred embodiment of the present invention, the depth of the second compression ring groove is greater than the radial thickness of the second compression piston ring, and a ratio of the radial thickness of the second compression piston ring to the depth of the second compression ring groove is less than 1.0, preferably 0.66 to 0.69.

As a preferred embodiment of the present invention, the first compression piston ring and the second compression piston ring have equal or unequal radial thicknesses, and a ratio of the radial thickness of the first compression piston ring to the radial thickness of the second compression piston ring is less than or equal to 1.0, preferably 0.8 to 0.9.

As a preferred embodiment of the present invention, the first compression piston ring and the second compression piston ring have equal or unequal axial thicknesses, and a ratio of the axial thickness of the first compression piston ring to the axial thickness of the second compression piston ring is less than or equal to 1.0, preferably 0.6 to 1.0.

As a preferred embodiment of the present invention, there is a difference in the ring gap size between the first compression piston ring and the second compression piston ring, and a ratio of the ring gap of the first compression piston ring to the ring gap of the second compression piston ring is less than 1.0, preferably 0.28 to 0.55.

To solve the technical problem, another engine piston assembly is provided, the piston assembly comprises a cylinder bore body with an inner wall, a piston body, a first compression piston ring, a second compression piston ring and an oil ring assembly; wherein, a top land, a first compression ring groove, a second land, a second compression ring groove, a third land, and an oil ring groove are disposed in turn on the periphery of the piston body from top to bottom; the first compression ring groove and the second compression ring groove have equal or unequal depths, and a ratio of the depth of the first compression ring groove to the depth of the second compression ring groove is less than or equal to 1.0; the first compression piston ring and the second compression piston ring have equal or unequal radial thicknesses, and a ratio of the radial thickness of the first compression piston ring to the radial thickness of the second compression piston ring is less than or equal to 1.0; a first annular expansion groove is disposed on the periphery of the second land, and a first expansion chamber is defined by the region between the first annular expansion groove and the wall of the cylinder bore; the depth of the second compression ring groove is greater than the radial thickness of the second compression piston ring; a second expansion chamber is defined by the crevice region between the second compression ring groove and the second compression piston ring; a second annular expansion groove is disposed on the periphery of the third land, and a third expansion chamber is defined by the region between the second annular expansion groove and the inner wall of the cylinder bore body, which is located in the middle of the third land.

To solve the technical problem, another engine piston assembly is provided, the piston assembly comprises a cylinder bore body with an inner wall, a piston body, a first compression piston ring, a second compression piston ring and an oil ring assembly; wherein, a top land, a first compression ring groove, a second land, a second compression ring groove, a third land, and an oil ring groove are disposed in turn on the periphery of the piston body from top to bottom; the first compression ring groove and the second compression ring groove have equal or unequal depths, and a ratio of the depth of the first compression ring groove to the depth of the second compression ring groove is less than or equal to 1.0; the first compression piston ring and the second compression piston ring have equal or unequal radial thicknesses, and a ratio of the radial thickness of the first compression piston ring to the radial thickness of the second compression piston ring is less than or equal to 1.0; a first annular expansion groove is disposed on the periphery of the second land, and a first expansion chamber is defined by the region between the first annular expansion groove and the wall of the cylinder bore; the depth of the second compression ring groove is greater than the radial thickness of the second compression piston ring; a second expansion chamber is defined by the crevice region between the second compression ring groove and the second compression piston ring; a second annular expansion groove is disposed on the periphery of the third land, and a third expansion chamber is defined by the region between the second annular expansion groove and the inner wall of the cylinder bore body, which is located in the middle of the third land; a fourth expansion chamber is defined by the crevice region between the oil ring groove and the oil ring assembly; the depth of the oil ring groove is greater than the radial thickness of the oil ring assembly; and a ratio of the radial thickness of the oil ring assembly to the depth of the oil ring groove is less than 1.0, preferably 0.66 to 0.69.

The present invention has the following advantages: in the engine piston assembly of the present invention, a piston structure, together with a piston ring set and a cylinder bore wall both matched to the piston structure, forms a special crevice passage with a function of multistage throttling and expansion. The crevice passage will generate high enough flow resistance and great energy dissipation effect in the compression, ignition and expansion processes of the fuel-air mixture of an engine cycle, and thus can effectively prevent the unburned high-pressure fuel-air mixture and the burned high-temperature and high-pressure gas from blow-by leaking out from the combustion chamber and the cylinder to the crankcase of the engine; and, in the exhaust process, the crevice passage can ensure that only few hydrocarbon emissions may escape from the crevices. The piston for an engine of the present invention can not only greatly and effectively reduce the intra-cylinder carbon deposition and the hydrocarbon emissions in the exhaust gas emissions of the engine, but also significantly improve the engine efficiency and the overall performance of the engine, so that the present invention is suitable for wide applications.

### BRIEF DESCRIPTION OF THE DRAWINGS

To describe the technical solutions in the embodiments of the present invention more clearly, the accompanying drawings to be used in the description of the embodiments will be briefly described below. Apparently, the accompanying drawings described hereinafter are some of the embodiments of the present invention, and a skilled person in the art can acquire other drawings according to these drawings without any creative effort, in which:

FIG. 1 is a sectional view of a engine piston assembly according to an embodiment of the present invention;

FIG. 2 is a sectional view of a piston body of FIG. 1;

FIG. 3 is a partially enlarged sectional view of the ring gap of a first compression piston ring of FIG. 1;

FIG. 4 is a partially enlarged sectional view of the ring gap of a second compression piston ring of FIG. 1; and

FIG. 5 is a sectional view of a engine piston assembly according to another embodiment of the present invention,

in which:
1: cylinder bore body;
2: piston body;
3: first compression piston ring;
4: second compression piston ring;
5: oil ring assembly;
201: top land;
202: first compression ring groove;
203: second land;
204: second compression ring groove;
205: third land;
206: oil ring groove;
207: piston skirt;
208: first annular expansion groove;
209: second annular expansion groove;
301: ring gap of the first compression piston ring; and
401: ring gap of the second compression piston ring.

### DETAILED DESCRIPTION OF THE INVENTION

To enable a further understanding of the present invention content of the invention herein, refer to the detailed description of the invention and the accompanying drawings below. Apparently, the embodiments described herein are a part of but not all of the embodiments of the present invention. All other embodiments obtained based on the embodiments in the present invention by one person of ordinary skill in the art without any creative effort shall fall into the protection scope of the present invention.

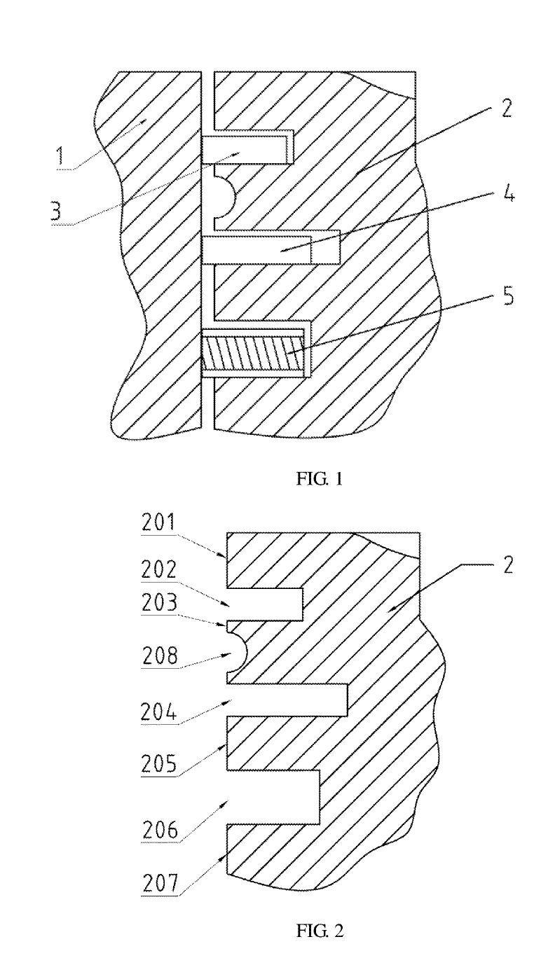

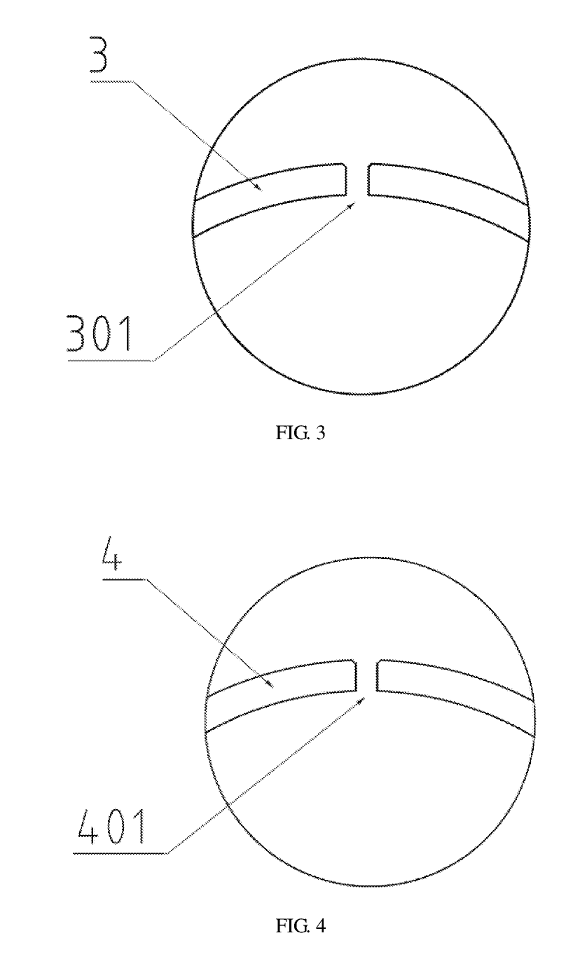

FIGS. 1-2 show a preferred embodiment of the present invention.

An engine piston assembly, comprises a cylinder bore body 1 with an inner wall, a piston body 2, a first compression piston ring 3, a second compression piston ring 4 and an oil ring assembly 5; the first compression piston ring 3, the second compression piston ring 4 and the oil ring assembly 5 each contacts with the inner wall of the cylinder bore body 1; a top land 201, a first compression ring groove 202, a second land 203, a second compression ring groove 204, a third land 205, an oil ring groove 206 and a piston skirt 207 are disposed in turn on the periphery of the piston body 2 from top to bottom; the first compression ring groove 202 and the second compression ring groove 204 have unequal depths, and a ratio of the depth of the first compression ring groove 202 to the depth of the second compression ring groove 204 is less than 1.0; a first annular expansion groove 208 is formed on the periphery of the second land 203, and a first annular expansion chamber is defined by the region between the first annular expansion groove 208 and the inner wall of the cylinder bore body 1; the first compression piston ring 3 and the second compression piston ring 4 have unequal radial thicknesses, and a ratio of the radial thickness of the first compression piston ring 3 to the radial thickness of the second compression piston ring 4 is less than 1.0; the depth of the second compression ring groove 204 is greater than the radial thickness of the second compression piston ring 4; and a second expansion chamber is defined by the crevice region between the second compression ring groove 204 and the second compression piston ring 4.

As described above, an angle formed by intersecting the surface of the second land 203 with the first compression ring groove 202 or the second compression ring groove 204 has a small chamfer.

Wherein, the first expansion chamber is arranged between the second land 203 and the inner wall of the cylinder bore body 1, and the first annular expansion groove 208 is located in the middle of the second land 203. An upper corner angle and a lower corner angle, which are formed by the surface of intersecting the first annular expansion groove 208 with the outer circumferential face of the second land 203, are kept sharp, without any chamfer or fillet.

Further, a ratio of the radial thickness of the second compression piston ring 4 to the depth of the second compression ring groove 204 is less than 1.0, preferably 0.66 to 0.69.

Still further, the first compression piston ring 3 and the second compression piston ring 4 have unequal radial thicknesses, and a ratio of the radial thickness of the first compression piston ring 3 to the radial thickness of the second compression piston ring 4 is less than 1.0, preferably 0.8 to 0.9; and the first compression piston ring 3 and the second compression piston ring 4 have equal or unequal axial thicknesses, and a ratio of the axial thickness of the first compression piston ring 3 to the axial thickness of the second compression piston ring 4 is less than or equal to 1.0, preferably 0.6 to 1.0.

As shown in FIG. 3-4, there is a difference in the ring gap size between the first compression piston ring 3 (301) and the second compression piston ring 4 (401), and a ratio of the ring gap 301 of the first compression piston ring 3 to the ring gap 401 of the second compression piston ring 4 is less than 1.0, preferably 0.28 to 0.55.

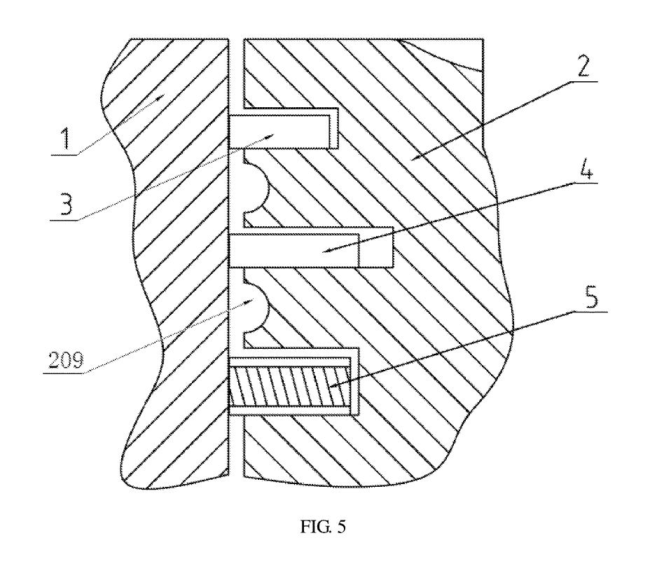

As shown in FIG. 5, in a case where an engine is running under a high cylinder pressure, the present invention further provides another engine piston assembly. The engine piston assembly comprises a cylinder bore body 1 with an inner wall, a piston body 2, a first compression piston ring 3, a second compression piston ring 4 and an oil ring assembly 5; the first compression piston ring 3, the second compression piston ring 4 and the oil ring assembly 5 each contacts with the inner wall of the cylinder bore body 1; a top land 201, a first compression ring groove 202, a second land 203, a second compression ring groove 204, a third land 205, an oil ring groove 206 and a piston skirt 207 are disposed in turn on the periphery of the piston body 2 from top to bottom; the first compression ring groove 202 and the second compression ring groove 204 have unequal depths, and a ratio of the depth of the first compression ring groove 202 to the depth of the second compression ring groove 204 is less than 1.0; a first annular expansion groove 208 is formed on the periphery of the second land 203, and a first annular expansion chamber is defined by the region between the first annular expansion groove 208 and the inner wall of the cylinder bore body 1; the first compression piston ring 3 and the second compression piston ring 4 have unequal radial thicknesses, and a ratio of the radial thickness of the first compression piston ring 3 to the radial thickness of the second compression piston ring 4 is less than 1.0; the depth of the second compression ring groove 204 is greater than the radial thickness of the second compression piston ring 4; a second expansion chamber is defined by the crevice region between the second compression ring groove 204 and the second compression piston ring 4; and a second annular expansion groove 209 is formed on the periphery of the third land 205, and a third expansion chamber is defined by the region between the second annular expansion groove 209 and the inner wall of the cylinder bore body 1, which is located in the middle of the third land 205.

In a case where an engine is running under a high cylinder pressure, the present invention further provides another engine piston assembly. The engine piston assembly comprises a cylinder bore body 1 with an inner wall, a piston body 2, a first compression piston ring 3, a second compression piston ring 4 and an oil ring assembly 5; the first compression piston ring 3, the second compression piston ring 4 and the oil ring assembly 5 each contacts with the inner wall of the cylinder bore body 1; a top land 201, a first compression ring groove 202, a second land 203, a second compression ring groove 204, a third land 205, an oil ring groove 206 and a piston skirt 207 are disposed in turn on the periphery of the piston body 2 from top to bottom; the first compression ring groove 202 and the second compression ring groove 204 have unequal depths, and a ratio of the depth of the first compression ring groove 202 to the depth of the second compression ring groove 204 is less than 1.0; a first annular expansion groove 208 is formed on the periphery of the second land 203, and a first annular expansion chamber is defined by the region between the first annular expansion groove 208 and the inner wall of the cylinder bore body 1; the first compression piston ring 3 and the second compression piston ring 4 have unequal radial thicknesses, and a ratio of the radial thickness of the first compression piston ring 3 to the radial thickness of the second compression piston ring 4 is less than 1.0; the depth of the second compression ring groove 204 is greater than the radial thickness of the second compression piston ring 4; a second expansion chamber is defined by the crevice region between the second compression ring groove 204 and the second compression piston ring 4; a second annular expansion groove 209 is formed on the periphery of the third land 205, and a third expansion chamber is defined by the region between the second annular expansion groove 209 and the inner wall of the cylinder bore body 1, which is located in the middle of the third land 205; a fourth expansion chamber (not shown) is defined by the crevice region between the oil ring groove 206 and the oil ring assembly 5; the depth of the oil ring groove 206 is greater than the radial thickness of the oil ring assembly 5; and a ratio of the radial thickness of the oil ring assembly 5 to the depth of the oil ring groove 206 is less than 1.0, preferably 0.66 to 0.69.

In the engine piston assembly of the present invention, from the combustion chamber to the crankcase, at least two stages of suddenly-converged throttling mechanism and suddenly-enlarged expansion mechanism for capturing the blow-by gas leakage are provided. Those mechanisms, together with the inner wall of the cylinder bore body 1, form a special crevice passage that has a function of multistage throttling and expansion. The crevice passage will generate high enough flow resistance and great energy dissipation effect in the compression, ignition and expansion processes of the fuel-air mixture of an engine cycle, and thus can effectively prevent the unburned high-pressure fuel-air mixture and the burned high-temperature and high-pressure gas from blow-by leaking out from the combustion chamber and the cylinder to the crankcase of the engine; and, in the exhaust process, the crevice passage can ensure that only few hydrocarbon emissions may escape from the crevices.

In conclusion, in the engine piston assembly of the present invention, a piston structure, together with a piston ring set and an inner wall of a cylinder bore body both matched to the piston structure, forms a crevice passage having at least one annular expansion chamber and also having a function of multistage throttling and expansion. The crevice passage will generate high enough flow resistance and great energy dissipation effect in the compression, ignition and expansion processes of the mixed fuel-air mixture of an engine cycle, and thus can effectively prevent the unburned high-pressure fuel-air mixture and the burned high-temperature and high-pressure gas from blow-by leaking out from the combustion chamber and the cylinder to the crankcase of the engine; and, in the exhaust process, the crevice passage can ensure that only few hydrocarbon emissions may escape from the crevices. The present engine piston assembly of the present invention can not only greatly and effectively reduce the intra-cylinder carbon deposition and the hydrocarbon emissions in the exhaust gas emissions of the engine, but also significantly improve the engine efficiency and the overall performance of the engine, so that the present invention is suitable for wide applications.

The protection scope of the present invention is not limited to each of embodiments described in this description. Any changes and replacements made on the basis of the scope of the present invention patent and of the description shall be included in the scope of the present invention patent.

1-10. (canceled)

11. A piston assembly for an engine, comprising:
a cylinder bore body with an inner wall;
a piston body;
a first compression piston ring;
a second compression piston ring; and
an oil ring assembly;
wherein,
the first compression piston ring, the second compression piston ring and the oil ring assembly each contacts with the inner wall of the cylinder bore body;
a top land, a first compression ring groove, a second land, a second compression ring groove, a third land, and an oil ring groove are disposed in turn on the periphery of the piston body from top to bottom;
more than one annular expansion chamber is disposed between the second land and the inner wall of the cylinder bore body, and the more than one annular expansion chamber is defined by the region between more than one annular expansion groove disposed on the periphery of the second land and the inner wall of the cylinder bore body;
so that a crevice passage with a multistage throttling and expansion is formed, which has a function of multistage throttling and expansion.

12. A piston assembly for an engine, the engine comprising:
a cylinder bore body with an inner wall;
a piston body;
a first compression piston ring;
a second compression piston ring; and
an oil ring assembly;
wherein,
the first compression piston ring, the second compression piston ring and the oil ring assembly each contacts with the inner wall of the cylinder bore body;
a top land, a first compression ring groove, a second land, a second compression ring groove, a third land, and an oil ring groove are disposed in turn on the periphery of the piston body from top to bottom;
at least one annular expansion chamber is disposed between the second land and the inner wall of the cylinder bore body, the at least one annular expansion chamber is defined by the region between at least one annular expansion groove disposed on the periphery of the second land and the inner wall of the cylinder bore body, and at least one annular expansion chamber is also disposed between the third land and the inner wall of the cylinder bore body, and the at least one annular expansion chamber is defined by the region between the at least one annular expansion groove disposed on the periphery of the third land and the inner wall of the cylinder bore body;
so that a crevice passage with a multistage throttling and expansion is formed, which has a function of multistage throttling and expansion.

13. A piston assembly for an engine, the engine comprising:
a cylinder bore body with an inner wall;
a piston body;
a first compression piston ring;
a second compression piston ring; and
an oil ring assembly;
wherein,
the first compression piston ring, the second compression piston ring and the oil ring assembly each contacts with the inner wall of the cylinder bore body;
a top land, a first compression ring groove, a second land, a second compression ring groove, a third land, and an oil ring groove are disposed in turn on the periphery of the piston body from top to bottom;
at least one annular expansion chamber is disposed between the third land and the inner wall of the cylinder bore body, and the at least one annular expansion chamber is defined by the region between the at least one annular expansion groove disposed on the periphery of the third land and the inner wall of the cylinder bore body;
so that a crevice passage with a multistage throttling and expansion is formed, which has a function of multistage throttling and expansion.

14. The piston assembly of claim 11, wherein one of the annular expansion chambers is disposed in a crevice region between the second compression piston ring and the second compression ring groove, so that a crevice passage with a multistage throttling and expansion is formed, which has a function of multistage throttling and expansion.

15. The piston assembly of claim 14, wherein the depth of the second compression ring groove is greater than the radial thickness of the second compression piston ring, and a ratio of the radial thickness of the second compression piston ring to the depth of the second compression ring groove is 0.66 to 0.69.

16. The piston assembly of claim 11, wherein the first compression piston ring and the second compression piston ring have equal or unequal radial thicknesses, and a ratio of the radial thickness of the first compression piston ring to the radial thickness of the second compression piston ring is 0.8 to 0.9.

17. The piston assembly of claim 11, wherein the first compression piston ring and the second compression piston ring have equal or unequal axial thicknesses, and a ratio of the axial thickness of the first compression piston ring to the axial thickness of the second compression piston ring is 0.6 to 1.0.

18. The piston assembly of claim 11, wherein there is a difference in the ring gap size between the first compression piston ring and the second compression piston ring, and a ratio of the ring gap of the first compression piston ring to the ring gap of the second compression piston ring is 0.28 to 0.55.

19. The piston assembly of claim 12,
wherein, one of the annular expansion chambers is disposed in a crevice region between the second compression piston ring and the second compression ring groove, so that a crevice passage with a multistage throttling and expansion is formed, which has a function of multistage throttling and expansion.

20. The piston assembly of claim 19,
wherein, a fourth expansion chamber is defined by the crevice region between the oil ring groove and the oil ring assembly;
the depth of the oil ring groove is greater than the radial thickness of the oil ring assembly;
and a ratio of the radial thickness of the oil ring assembly to the depth of the oil ring groove is 0.66 to 0.69;
so that a crevice passage with a multistage throttling and expansion is formed, which has a function of multistage throttling and expansion.

21. The piston assembly of claim 19, wherein the depth of the second compression ring groove is greater than the radial thickness of the second compression piston ring, and a ratio of the radial thickness of the second compression piston ring to the depth of the second compression ring groove is 0.66 to 0.69.

22. The piston assembly of claim 19, wherein the first compression piston ring and the second compression piston ring have equal or unequal radial thicknesses, and a ratio of the radial thickness of the first compression piston ring to the radial thickness of the second compression piston ring is 0.8 to 0.9.

23. The piston assembly of claim 12, wherein the first compression piston ring and the second compression piston ring have equal or unequal axial thicknesses, and a ratio of the axial thickness of the first compression piston ring to the axial thickness of the second compression piston ring is 0.6 to 1.0.

24. The piston assembly of claim 12, wherein there is a difference in the ring gap size between the first compression piston ring and the second compression piston ring, and a ratio of the ring gap of the first compression piston ring to the ring gap of the second compression piston ring is 0.28 to 0.55.

25. The piston assembly of claim 13, wherein one of the annular expansion chambers is disposed in a crevice region between the second compression piston ring and the second compression ring groove, so that a crevice passage with a multistage throttling and expansion is formed, which has a function of multistage throttling and expansion.

26. The piston assembly of claim 25, wherein the depth of the second compression ring groove is greater than the radial thickness of the second compression piston ring, and a ratio of the radial thickness of the second compression piston ring to the depth of the second compression ring groove is 0.66 to 0.69.

27. The piston assembly of claim 13, wherein the first compression piston ring and the second compression piston ring have equal or unequal radial thicknesses, and a ratio of the radial thickness of the first compression piston ring to the radial thickness of the second compression piston ring is 0.8 to 0.9.

28. The piston assembly of claim 13, wherein the first compression piston ring and the second compression piston ring have equal or unequal axial thicknesses, and a ratio of the axial thickness of the first compression piston ring to the axial thickness of the second compression piston ring is 0.6 to 1.0.

29. The piston assembly of claim 13, wherein there is a difference in the ring gap size between the first compression piston ring and the second compression piston ring, and a ratio of the ring gap of the first compression piston ring to the ring gap of the second compression piston ring is 0.28 to 0.55.

30. The piston assembly of claim 25,
wherein,
an expansion chamber is defined by the crevice region between the oil ring groove and the oil ring assembly;
the depth of the oil ring groove is greater than the radial thickness of the oil ring assembly;
and a ratio of the radial thickness of the oil ring assembly to the depth of the oil ring groove is 0.66 to 0.69;
so that a crevice passage with a multistage throttling and expansion is formed, which has a function of multistage throttling and expansion.
